(19) United States
(12) Patent Application Publication
(10) Pub. No.: US 2007/0065538 A1
(43) Pub. Date: Mar. 22, 2007

(54) Molding system having valve including pump

(75) Inventors: Douglas J. Weatherall, Bolton (CA); Jim Pilavdzic, Milton, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/228,071

(22) Filed: Sep. 16, 2005

(51) Int. Cl. B29C 45/20

(52) U.S. Cl. 425/568

(57) ABSTRACT

Disclosed is a kit of a molding system, a valve of a molding system, and a molding system. Each of the kit and the molding system includes a pump configured to be placed in a valve pathway defined by a valve, wherein the pump is configured to pump, responsive to actuation by a pump actuator, a molding material through the valve pathway and towards a mold cavity defined by complementary mold halves. The valve includes a valve body and a pump configured to be placed in a valve pathway defined by the valve body, wherein the pump is configured to pump, responsive to actuation by a pump actuator, a molding material through the valve pathway and towards a mold cavity defined by complementary mold halves.

### FIELD OF THE INVENTION

The present invention generally relates to molding systems, and more specifically, the present invention relates: to a kit of a molding system including a pump, the pump configured to pump molding material along a valve pathway defined by a molding system valve; to a molding machine valve including a pump, the pump configured to pump molding material along a valve pathway defined by the molding system valve; and to a molding system including a molding machine valve having a pump, the pump configured to pump molding material along a valve pathway defined by the molding system valve.

### BACKGROUND

FIG. 1 represents known molding machine valves. A valve 1 is a ball check valve, and a valve 10 is a ring check valve. Known non-return valves are installed, for example, on a tip of a processing screw (hereafter called the “screw”, and also called a “plasticizing” screw). The screw is mounted in a molding machine barrel (hereafter called the “barrel”) and connected to mechanisms that rotate and translate the screw. When the screw is rotated, the screw forces a molding material forwardly which then forces the valve to open and receive forwardly advancing molding material. Once enough molding material is accumulated downstream of the valve, the screw is stopped from rotating. Then the screw is accelerated forwardly forcing the valve to close and causing the accumulated molding material out from the barrel and into a mold cavity defined by complementary mold halves once a shutoff nozzle (that is located between the barrel and the mold cavity) is opened. When the screw is translated forwardly, the valve should close quickly and remain in a closed position that prevents a back flow of molding material back to the screw. Hence, the term “non-return” means that the valve prevents the molding material from flowing back to the screw as the molding material is injected into the mold cavity. Known valves attempt to prevent backflow but do so with unsatisfactory results.

For example, known non-return valves are described in U.S. Pat. No. 6,007,322 (published in 1999), U.S. Pat. Nos. 5,756,037, 5,112,213, 4,643,665, 4,105,147, 3,726,309, 3,590,439 and 3,344,477 (issued in 1967). Known valves, for at least 30 years (and/or more), have suffered and continue to suffer from a high shot-to-shot variability (hereafter called the “shot variability”). In other words, each shot injected into a mold cavity differs from each other in terms of volume and/or in terms of mass. It is desired to have a low-shot variability, in that each injected shot is substantially repeatable by volume and/or by mass. This is also known as shot “repeatability”. If shot size varies, the molded articles are not filled with an optimum amount of weight and/or volume of molding material. Also, state-of-the-art thinking leads one to believe that if shot sizes vary, then the injection pressure “profiles” (that is, the pressure profile is a change in the injection pressure during injection of the melt over an injection cycle time) will vary which then reduces article quality.

Several known theories for resolving the problem of shot variability are currently promoted. One theory suggests that to resolve the problem of low-shot repeatability, molding machines should include the use of a closed-loop injection unit control, either with servo-electric valves on a hydraulic machine or AC servomotors on an all-electric machine. Another theory suggests that to resolve the problem, molding machines should include screws designed to meet the requirements of the melt and of the motor output that drives the screw. These theories attempt to resolve the high-shot variability problem; however, over a span of over 30 years, the problem appears to persist and continue without a satisfactory outcome on the horizon.

Referring to FIG. 1, known “ball-type” non-return valves 1 are described in U.S. Pat. Nos. 4,362,496, 4,305,902, 3,335,461, and 3,099,861 (hereafter called the '496, the '902, the '461, and the '861 respectively). Although a metallic ball 4 is used to seal a melt channel, the ball-type non-return valve 1 can be problematic when achieving shot repeatability. During the injection stroke of the screw, a variable amount of the molding material will leak past the metallic ball 4 as it is carried to its seat 6 by the flowing melt. Also, the force of gravity typically maintains the ball 4 against one side of a chamber 2 possibly creating a significant gap opposite a contact surface. Movement of the ball 4 to its seat 6 can be hindered by friction between the ball 4 and a surface of the chamber 2, and the pressure applied to the ball 4 by melt flowing through the gap. The hindrance of the movement of the ball 4 causes the melt channel to be open for an extended time, allowing increased backflow to occur.

The '496 and the '902 describe a feeding unit that is separated from a shooting pot by a ball check valve. The valve closes once a predetermined amount of molding material has been urged into the shooting pot. It appears that the '496 and the '902 do not teach an approach for improving shot repeatability of the valve.

The '461 describes a valve assembly having a series of short cylindrical rollers around a central portion. The rollers act similarly to a ball in that they move axially during injection and recovery to seal off the inlets and outlets of the valve. It appears that the '461 does not teach an approach for improving shot repeatability of the valve.

The '861 describes a valve structure having one or more balls in an equal number of ball-receiving pockets. The balls move between a forward position during recovery and a rearward position during injection. It appears that the '861 does not teach an approach for improving shot repeatability of the valve.

Known “slidable ring type” non-return valves include a slidable ring, and are described in U.S. Pat. Nos. 6,203,311, 5,240,398, 4,477,242, 6,155,816, 5,167,971, and Japanese Patent 3,474,328 (hereafter called the '311, the '398, the '242, the '816, the '971 and the '328 respectively).

The '816, '971, and '311 appear to teach an approach for resolving the problem of improving shot repeatability by increasing a wear resistance of the valve components. An abutment of a sliding ring on retainers during an injection cycle may wear down the sliding ring and/or the retainers, which would increase a closing stroke of the sliding ring that then may allow an inadvertent increase of backflow. In this approach, the sliding ring and retainers are typically made of (or coated with) a wear resistant material. Alternatively, the components are arranged to reduce contact surface so that wearing of the slide ring and the retainers is less drastic over time. Closing of these types of valves during injection is accomplished by both friction between ring and barrel holding the ring in place on the barrel as the tip is moved forward by the screw, and the increasing pressure acting on the downstream face of the ring pushing the ring to the seat. The '311 also describes a method of improving shot repeatability by improving a closing rate of the sliding ring by reducing a distance the sliding ring is required to travel (see column 3 from line 56 to line 62, and column 4 from line 42 to line 49). Molding material has to travel a short distance into the inlet and since the fluid is typically a compressible fluid, the pressure drop across the inlet opening is then minimized. Friction between the ring and barrel holds the ring in place as the screw moves forward and, presumably, the short stroke of the sliding ring minimizes valve leakage during injection of the molding material by closing the valve before the screw is translated forwardly a substantial distance.

'398 and the '328 disclose additional designs for sliding ring, non-return valves. It appears that the '398 and the '328 do not teach an explicit approach for improving shot repeatability of the valve.

Known “mixing” non-return valves are described in U.S. Pat. Nos. 5,439,633, 5,158,784, and 3,936,038, and U.S. Patent Application 2003/0232106 A1 (hereafter called the '633, the '784, the '038, and the '106 respectively). The '633, the '784, the '038, and the '106 appear to teach incorporating mixing elements into known non-return valves. Presumably, the mixing structures further melt the plastic resin and/or improve the homogeneity of the molding material. Improving homogeneity is important in applications where additives, such as coloring and/or softening agents, are added to the molding material prior to injection. Specifically, the '784, the '038, and the '106 each appear to teach mixing non-return valves based on designs having sliding rings. Specifically, the '633 appears to teach the use of a poppet to close the valve. It appears the '633, the '784, the '038, and the '106 do not teach an explicit approach for improving shot repeatability of the valve.

U.S. Pat. No. 5,164,207 discloses a (nondriven type) poppet type valve having a spring configured to retract the poppet prior to injection.

Known “driven” type non-return valves are described in U.S. Pat. Nos. 4,105,147, 5,112,213, and 6,533,567 (hereafter called the '147, the '213, and the '567 respectively). Preclosure of the valve is presumed to minimize (or eliminate) valve leakage during injection of the molding material. The '147, the '213, the '207 and the '567 appear to teach an approach that includes a mechanical structure of the valve prior to injection (as opposed to relying on pressure as previously discussed with the '311). The '147, the '213, and the '567 each appear to teach sliding ring valves that close upon reverse rotation of the screw.

U.S. Pat. No. 4,988,281 (hereafter called the '281) discloses a screw head structure that is configured to drive a sliding ring back by a reverse rotation of a processing screw prior to injection of molding material. It appears that the '281 takes an approach for improving shot repeatability by driving the sliding ring back against a rearward retainer. The '281 does not appear to mention the pressure drop across the valve during recovery.

Generally, the closing stroke of a sealing mechanism may be an important factor in determining shot repeatability. A short closing stroke reduces time required to close the valve thereby decreasing the occurrence of backflow. A high pressure drop that forms across the valve as a result is advantageous in closing the valve quickly as it results in a high force urging the sealing mechanism toward the seat. In the case of the ring type check valve, a tight fit on the barrel is also advantageous since it acts to hold the ring in place during forward movement of the screw, also helping the closing action and thereby properly filling a mold cavity and improving shot repeatability. However, during a recovery cycle, it is preferred to have a low pressure drop across the valve, allowing molding material to flow through the valve and into the accumulation area with less resistance. A short closing stroke can be problematic since it retards forward flow of melt through the valve. Also, a tight fit on the barrel can lead to rapid wear on the retainer, due to the increased frictional loading at the interface between the ring and the retainer as the screw rotates and moves back during recovery. It appears that designing a non-return valve becomes a dilemma of choosing between either sacrificing recovery rates and/or wear and/or sacrificing shot repeatability.

JP 9262872 (Assignee: Sekisui Chemical Company Limited; Inventor: Ihara) discloses a valve which is not used as a non-return valve in a molding machine, but rather this valve is used in hot runner manifold of a molding machine. The problems to be solved (as described in JP 9262872) are: in the structure of the valve gate as described in said patent gazette No. S63-109032, solid matter of molten resin which may be accumulated in the nozzle hinders the working of the valve pin, preventing the valve pin from completely blocking the gate. Thus, residual molten resin around the gate opening causes so-called flash. In addition, a problem lies in that accumulation of said solid matter of molten resin breaks the valve pin because of improper working of the valve pin. In the injection molding die of the present invention, screw threads are helically formed near the leading end of a valve pin in the direction opposite to the one in which the valve pin moves forward, and the valve pin is designed to move forward while rotating. Therefore, solid matter of molten resin created on the so-called land near the gate is transferred through the screw threads to the molten resin in the nozzle after the gate has been blocked. This prevents the solid matter of molten resin from being included in a molded product and allows for obtaining a satisfactory injection-molded product free from any flash or flaw mark. This patent appears to teach rotating the screw to move the solidified molding material back into the nozzle and to avoid moving the solidified molding material into the mold cavity. It appears the structure described in JP 9262872 is inserted into the molding material flow pathway so as to restrict the flow of molding material and thus cause a pressure drop in the pathway.

U.S. Pat. No. 6,679,697 (Assignee: Husky Injection Molding Systems Limited; Inventor: Bouti) discloses, for a nozzle of a hot runner assembly, a flow deflector apparatus and method in an injection molding system which transitions a flowing medium around an obstruction, said flowing medium exhibiting reduced stagnation points and substantially uniform flow characteristics downstream of the obstruction. Disadvantageously, the flow deflector may present a constant pressure drop that acts against the flow of the molding material, and thus reduces the filling efficiency of the mold cavity. If filling efficiency is an issue, a person skilled in the art would be motivated to remove the flow deflector to improve filling efficiency, and would configured the channel of a nozzle to remain unobstructed and free from any mechanisms.

### SUMMARY

In a first aspect of the present invention, there is provided a kit of a molding system, including a pump configured to be placed in a valve pathway defined by a valve, wherein the pump is configured to pump, responsive to actuation by a pump actuator, a molding material through the valve pathway and towards a mold cavity defined by complementary mold halves.

In a second aspect of the present invention, there is provided a valve of a molding system, including a valve body, and a pump configured to be placed in a valve pathway defined by the valve body, wherein the pump is configured to pump, responsive to actuation by a pump actuator, a molding material through the valve pathway and towards a mold cavity defined by complementary mold halves.

In a third aspect of the present invention, there is provided a molding system, including a pump configured to be placed in a valve pathway defined by a valve, wherein the pump is configured to pump, responsive to actuation by a pump actuator, a molding material through the valve pathway and towards a mold cavity defined by complementary mold halves.

A technical effect of the aspects of the present invention is improved operation of a molding system as described further below in the embodiments of the present invention.

A specific technical effect of the first aspect of the present invention is, when a valve is attached to a processing screw of a molding machine, that a pump improves shot repeatability of the valve by reducing molding material backflow during injection of molding material into a mold cavity while permitting an increased rate of recovery of molding material during a recovery cycle of the molding machine. Improved shot repeatability improves prediction of an amount of molding material to be accumulated, which results in reduction in molding material costs and improved molded article quality.

### BRIEF DESCRIPTION OF THE FIGURES

Exemplary embodiments of the present invention will be described, with reference to the following Figures and the detailed description of the exemplary embodiments:

FIG. 1 represents known molding machine valves;

FIG. 2 is a longitudinal cross-sectional view of a valve according to a first embodiment;

FIG. 3 is a longitudinal cross-sectional view of a valve according to a second embodiment;

FIG. 4 is a longitudinal cross-sectional view of a valve according to a third embodiment;

FIG. 5 is a longitudinal cross-sectional view of a valve according to a fourth embodiment;

FIG. 6 is a longitudinal cross-sectional view of a valve according to a fifth embodiment;

FIG. 7 is an elevated perspective cross-sectional view of a valve according to a sixth embodiment;

FIG. 8 is a longitudinal cross-sectional view of a valve according to a seventh embodiment;

FIG. 9 is a longitudinal cross-sectional view of a valve according to an eighth embodiment;

FIG. 10 represents the valve of FIG. 9 at various rotational positions;

FIG. 11 is a graph showing an operation curve of the valve of FIG. 2; and

FIG. 12 is a cross-sectional view of a hot runner assembly according to a ninth embodiment.

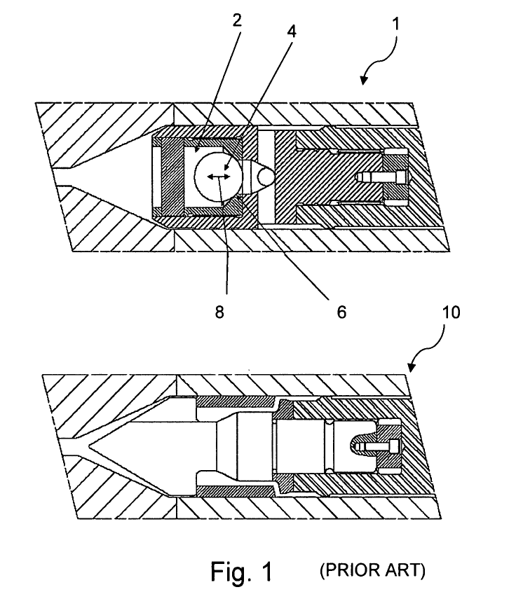

### DETAILED DESCRIPTION OF THE EXEMPLARY EMBODIMENTS

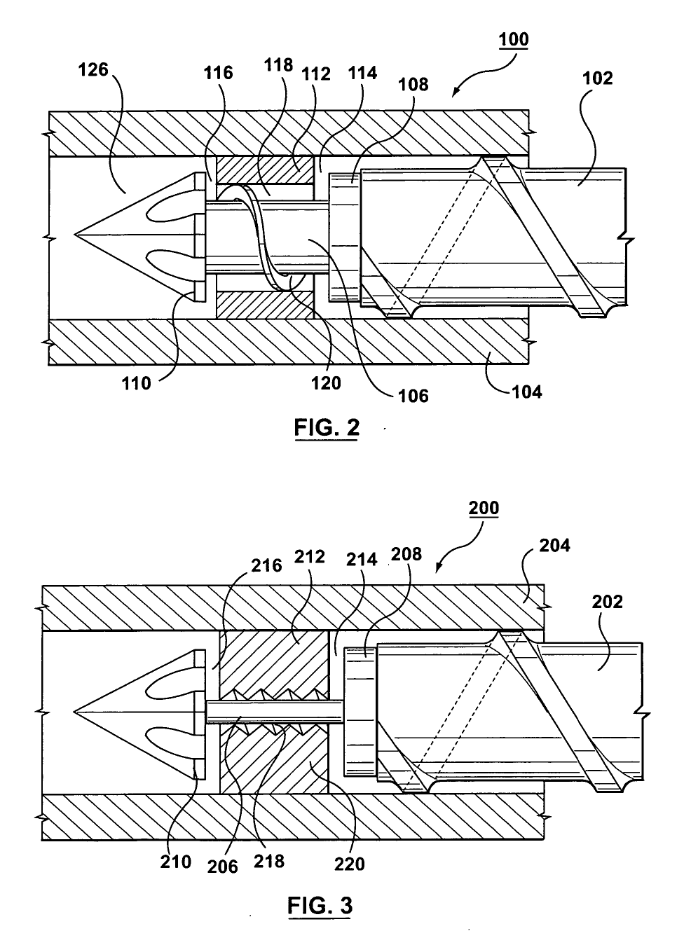

FIG. 2 is a longitudinal cross-sectional view of valve 100 (hereafter called the “valve” 100) according to the first embodiment, which is the preferred embodiment.

The valve 100 includes a valve body, and the valve body includes a collection of valve body components 106, 108, 110 and 112. The valve 100 is configured to control flow of a molding material associated with a molding system (such as an injection unit and/or a hot runner assembly). The valve 100 defines an ingress 114, an egress 116 and a valve pathway 118 (hereafter called the “pathway” 118) extending from the ingress 114 to the egress 116. The valve 100 also includes a pump 120, and the pump 120 is configured to be placed in the valve pathway 118 defined by the valve 100, wherein the pump 120 is configured to pump, responsive to actuation by a pump actuator, the molding material through the valve pathway 118 and towards a mold cavity (not depicted) defined by complementary mold halves (not depicted). The pump actuator is shown in FIG. 2 as a molding material processing structure (depicted, for example, as a processing screw 102) of a molding machine (not depicted). Other embodiments contemplate other types of pump actuators. The pump 120, when actuated, pumps the molding material forwardly along the pathway 118, and when de-actuated, to resist backflow of the molding material along the pathway 118 away from the mold cavity (for example, back to the screw 102). The pump 120 depicted in FIG. 2 is a screw pump. Other types of pumps are contemplated and described below.

According to a variation, it will be appreciated that the valve 100 is supplied along with the pump 120. In another variation, the valve 100 and the pump 120 are supplied separately, and in this case the pump 120 is supplied as a member of a kit which is sold to an end-user, and the end-user integrates the pump 120 with the valve 100.

A technical effect of the pump 120 is that it improves shot repeatability of the valve 100 by reducing molding material backflow during injection of molding material into a mold cavity while permitting an increased rate of recovery of molding material during a recovery cycle of the molding machine. Improved shot repeatability allows a better prediction of an amount of molding material to be accumulated, which results in reduction in molding material costs and improved molded article quality.

Other embodiments, described below, contemplate the use of many types of pumps. Pumps can be classified as dynamic-type pumps (e.g.: centrifugal, axial, turbine, screw, etc) or as positive-displacement pumps (e.g.: reciprocating, rotary, gear, etc). Generally, a pump is configured to move or transfer a fluid, and is also configured to add a head pressure to the liquid being moved or transferred (that is, pumped).

When the valve 100 is attached to the screw 102, the pump 120 is configured to pump the molding material forwardly along the pathway 118 as the screw 102 is made to rotate in the pathway 118 during a recovery cycle of the molding machine. The screw 102 is translated forwardly in order to close the valve 100, and before the valve 100 is made to close, the screw flight of the pump 120 resists backflow of the molding material along the pathway 118 during an injection cycle of the molding machine.

Specifically, the valve 100 passes the molding material into an accumulation zone 126 during a recovery cycle of an injection unit (not depicted) of the molding machine, but prevents backflow of the molding material during the injection cycle. A barrel 104 of the injection unit is sized to receive the screw 102 therein. The screw 102 is known as a molding material processing screw that is used to process molding material as known in the art.

According to the first embodiment, the collection of body components 106, 108, 110 and 112 includes a rearward retainer 108, a central portion 106 (hereafter called the “shaft 106”), a forward retainer 110 and a slide ring 112. The retainer 108 and the shaft 106 form a single integral component or the retainer 110 and the shaft 106 may form a single integral component. Preferably, the body components are all separate and individual components.

The rearward retainer 108 detachably attaches to a distal end of the screw 102. For example, extending from the rearward retainer 108 is a threaded shaft (not depicted) that threads onto a mating portion (not depicted) of the distal end of the screw 102. The shaft 106 attaches to the rearward retainer 108 and extends away from the screw 102 and to the accumulation zone 126. The sliding ring 112 is slidably inserted over the shaft 106. The forward retainer 110 is attached to a distal end of the shaft 106. Once assembled, the ring 112 is slidably movable between the rearward retainer 108 and the forward retainer 110. The forward retainer 110 and the rearward retainer 108 have outer diameters larger than an inner diameter of the sliding ring 112 so that the forward retainer 110 and the rearward retainer 108 define extents of axial movements of the sliding ring 112 coaxially along the shaft 106. The sliding ring 112 is shaped to fit within the barrel 104. The ingress 114 is defined between the sliding ring 112 and the rearward retainer 108. The egress 116 is defined between the sliding ring 112 and the forward retainer 110. The sliding ring 112 and the shaft define the pathway 118 therebetween that extends from the ingress 114 to the egress 116.

According to the first embodiment, the pump 120 (which is depicted as a screw pump) includes a helical screw flight that extends radially from the shaft 106 and extends into the pathway 118 to the sliding ring 112. Another name for the helical screw flight is an impeller.

In an alternative, the pump 120 also includes another screw flight (not depicted) that is configured to extend into the pathway 118, and is aligned out of phase relative to the screw flight (depicted) of the pump 120. The another screw flight and the depicted screw flight form a double helix of screw flights in which the screw flights do not touch one another. Alternatively, the double helix of screw flights touch one another at predetermined locations.

In an alternative, the pump 120 includes a uniform bolt thread. A bolt thread usually satisfies an exacting, uniform thread specification. On the other hand, a screw thread (or a screw flight that is helically flighted) may or may not meet the above definition of the bolt thread (which means that the screw flight may not conform to standard bolt thread specifications). Generally, the screw flight or the bolt thread is a ridge or a rib that wraps around a surface of an elongated body (such as a cylinder or a shaft for example) and extends along a longitudinal axis of the elongated body as it wraps around therewith. The ridge can also be aligned in a noncurved manner. The ridge (also called the screw flight) may extend continuously without interruption or may extend with regular or irregular interruptions along its alignment. The screw flight of the pump 120 may have any one of a square shaped profile, a v-shaped profile and any combination and permutation thereof. Referring back to FIG. 2, it will be appreciated that the lead of the screw flight (or the thread) of the pump 120 is in the same direction as that of the screw 102 (also known as a feed screw) so that the pump 120 works in concert with the screw 102 and not work against the flow of molding material moved by the screw 102.

In operation, following injection of an accumulated shot of molding material, the screw 102 is rotated which forces the molding material into the ingress 114, along the pathway 118 and out through the egress 116 and into the accumulation zone 126. As the screw 102 rotates, so does the screw flight of the pump 120 due to its attachment to the shaft 106 (which is attached to the screw 102 through the rearward retainer 108). In a preferred embodiment; the ring 112 frictionally engages the barrel 104, and (preferably) the ring 112 does not rotate when the screw flight of the pump 120 is made to rotate. In an alternative, the ring 112 rotates but not at the same rate of rotation as the pump 120 (the pump 120 will have some effect whether the ring 112 rotates or not). Preferably, relative motion between the rotating screw flight of the pump 120 and the stationary sliding ring 112 creates a pumping action within the pathway 118 that also further urges molding material through the passageway 118. Clearance between the tip of the flight screw and the inner diameter of the slidable ring 112 is sufficient enough to permit rotation of the screw flight without accidentally seizing the valve 100 and thus prevent rotation of the screw flight while the screw 102 is rotating.

The screw 102 continues rotating and translating rearwardly until a predetermined volume of molding material has been accumulated in the accumulation zone 126. Preferably, once a desired shot volume has been reached, the screw 102 stops rotating and is then stroked forwardly by a piston (not depicted) or other equivalent mechanism. In an alternative, the screw 102 keeps turning while initially translating the screw 102 forwardly until the ring 112 has closed off the ingress 114. The turning screw 102 would keep pump 120 pushing the melt against a backflow generated by the advancing screw 102 and thereby better minimize leakage instead of relying solely on friction induced by the pump 120 against the backflow. Preferably, the sliding ring 112 remains stationary due to friction engagement with the barrel 104 until an injection stroke of the screw 102 is initiated that causes the sliding ring 112 to abut the rearward retainer 108, thereby sealing the ingress 114. Pressure exerted by the screw 102 moving forwardly to the accumulation zone 126 generates significant backpressure that may force some of the accumulated shot back through the pathway 118 and out of the ingress 114 back to the screw 102. Movement of the molding material back through the pathway 118 may begin when the processing screw 102 is stroked forward and before the sliding ring 112 abuts the rearward retainer 108 and seals the ingress 114.

According to the first embodiment, during rotation of the screw 102, pumping action of the pump 120 as it rotates against the inner surface of the ring 112 conveys resin forward in the manner that is similar to how a metering section of the screw 102 pumps molding material. During injection, the pressure drop across the valve 100 would be high since a path along which the molding material would flow would be a helix having a longer path than a straight annulus.

The ingress 114 and the egress 116 may be varied in location and shape. For example, FIG. 2 depicts the ingress 114 as being axially aligned between the rearward retainer 108 and the slide ring 112 so that the seat members (that are defined by the slide ring and the retainer 108) are aligned axially relative to the screw 102. In a variation (not depicted), the ingress 114 is aligned longitudinally so that the seat members are also aligned longitudinally. In another example, FIG. 2 depicts the egress 116 formed as grooves in the forward retainer 110 that cooperate with the slide ring 112, and the slide ring 112 does not define any grooves. In a variation (not depicted), the egress 116 is formed as grooves in the ring member 112 and the forward retainer 110 does not define any grooves. These variations in the ingress 114 and the egress 116 are well known in the art.

FIG. 3 is the longitudinal cross-sectional view of a valve 200 (hereafter called the “valve 200”) according to the second embodiment.

The valve 200 includes a collection of body components 206, 208, 210 and 212. The valve 200 also includes a pump 220.

The collection of body components 206, 208, 210 and 212 is configured to cooperate with each other, attach to a molding material processing structure (not depicted) of a molding machine (not depicted), and define an ingress 214, an egress 216 and a valve pathway 218 (hereafter called the “pathway” 281) extending from the ingress 214 to the egress 216. The pump 220 is configured to cooperate with the pathway 218, to pump a molding material (not depicted) forwardly along the pathway 218, and to resist backflow of the molding material along the pathway 218. The body components 206, 208, 210 and 212 are similar to the body components of the first embodiment, and are generally arranged in the manner similar to that of the first embodiment. A molding material processing screw 202 (hereafter called the “screw”202) is located within a barrel 204 of a molding machine (not depicted).

According to the second embodiment, the pump 220 includes a screw flight that is attached to the slidable ring 212, extends radially from the slidable ring 212 and extends into the pathway 218 to the shaft 206. The pump 220 is configured to extend into and cooperate with the pathway 218, to pump a molding material forwardly along the pathway 218, and to resist backflow of the molding material along the pathway 218.

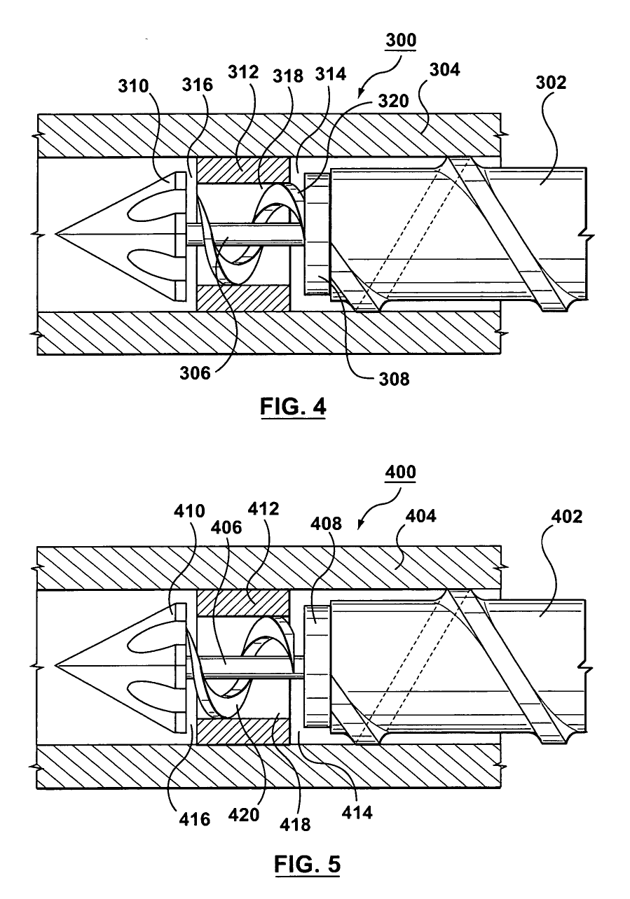

FIG. 4 is the longitudinal cross-sectional view of a valve 300 (hereafter called the “valve 300”) according to the third embodiment.

The valve 300 includes a collection of body components 306, 308, 310 and 312. The valve 300 also includes a pump 320. The body components 306, 308, 310 and 312 are similar to the body components of the first embodiment, and are arranged in the manner similar to that of the first embodiment. A processing screw 302 (hereafter called the “screw 302”) is located within a barrel 304 of a molding machine (not depicted). The body components 306, 308, 310 and 312 define an ingress 314, an egress 316, and a valve pathway 318 (hereafter called the “pathway” 318) that extends from the ingress 314 to the egress 316.

According to the third embodiment, the pump 320 is configured to extend into and cooperate with the pathway 318, to pump a molding material forwardly along the pathway 318, and to resist backflow of the molding material along the pathway 318. Specifically, the pump 320 includes a screw flight attached to the rearward retainer 308 that spans a length of the shaft 306 to the forward retainer 310, extends to the slidable ring 312, and extends to the shaft 306.

FIG. 5 is the longitudinal cross-sectional view of a valve 400 (hereafter called the “valve 400”) according to the fourth embodiment.

The valve 400 includes a collection of body components 406, 408, 410 and 412. The valve 400 also includes a pump 420. The body components 406, 408, 410 and 412 are similar the body components of the first embodiment, and are arranged in the manner similar to that of the first embodiment. A processing screw 402 (hereafter called the “screw 402”) is located within a barrel 404 of a molding machine (not depicted). The body components 406, 408, 410 and 412 define an ingress 414, an egress 416, and a valve pathway 418 (hereafter called the “pathway” 418) that extends from the ingress 414 to the egress 416.

According to the fourth embodiment, the pump 420 is configured to extend into and cooperate with the pathway 418, to pump a molding material forwardly along the pathway 418, and to resist backflow of the molding material along the pathway 418. The pump 420 includes a screw flight that attaches to the forward retainer 410, spans a length of the shaft 406 to the rearward retainer 408, extends to the slidable ring 412 and extends to the shaft 406.

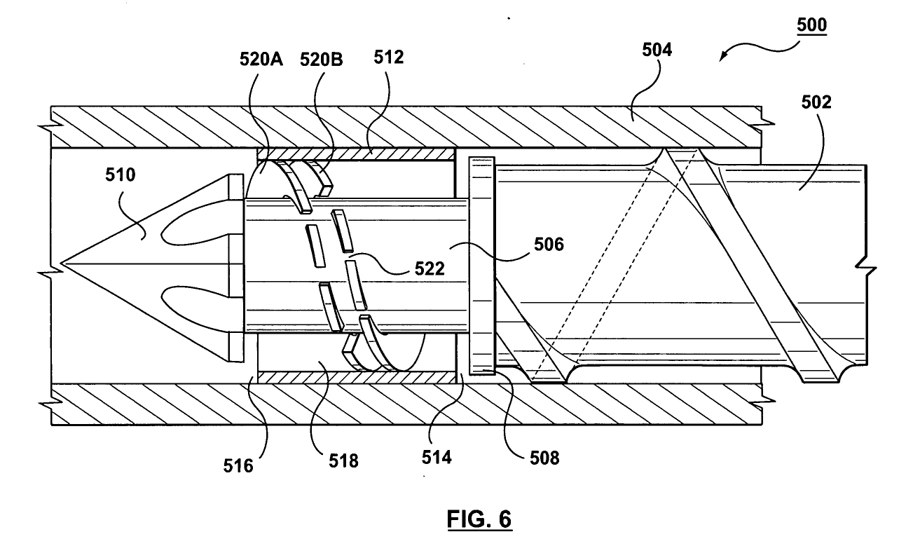

FIG. 6 is the longitudinal cross-sectional view of a valve 500 (hereafter called the “valve 500”) according to the fifth embodiment.

The valve 500 includes a collection of body components 506, 508, 510 and 512. The valve 500 also includes a first pump 520A and a second pump 520B. The body components 506, 508, 510 and 512 are similar the body components of the first embodiment, and are arranged in the manner similar to that of the first embodiment. A processing screw 502 (hereafter called the “screw 502”) is located within a barrel 504 of a molding machine (not depicted). The body components 506, 508, 510 and 512 define an ingress 514, an egress 516, and a valve pathway 518 (hereafter called the “pathway” 518) that extends from the ingress 514 to the egress 516.

According to the fifth embodiment, the pumps 520A and 520B are configured to extend into and cooperate with the pathway 518, to pump a molding material forwardly along the pathway 518, and to resist backflow of the molding material along the pathway 518. The pumps 520A and 520B each include discontinuous screw flights attached to the shaft 506 and extend radially from the shaft 506 to the slidable ring 512. The discontinuous screw flight of the first pump 520A is aligned to be out of phase from the discontinuous screw flight of the second pump 520B. The continuous portions of the second pump 520B are aligned with the discontinuous portions of the first pump 520A such that backflow passing through the discontinuities of the first pump 520A will be redirected by the second screw flight 520B. Similarly, the discontinuous portions of the second pump 520B, as shown as a discontinuity 522, are aligned with the continuous portions of the first pump 520A.

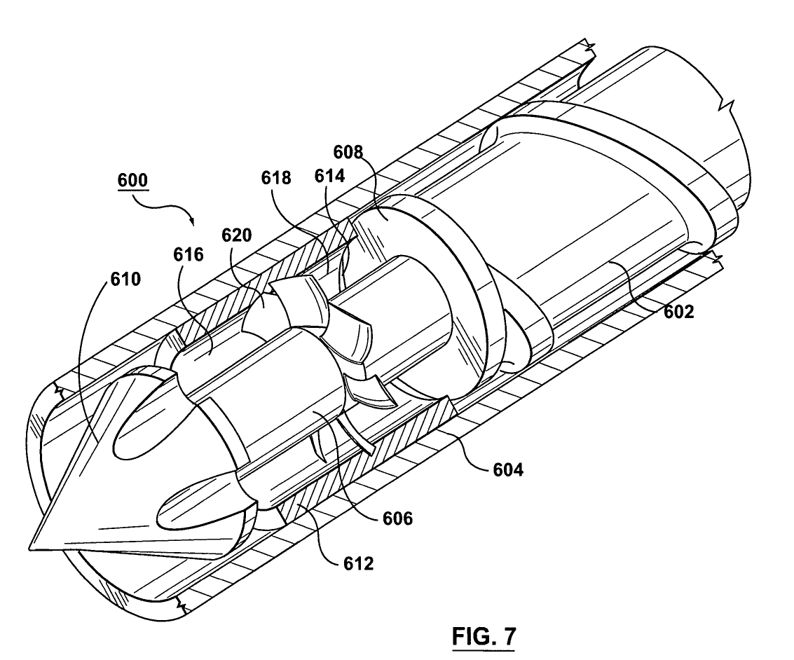

FIG. 7 is the elevated perspective cross-sectional view of a valve 600 (hereafter called the “valve 600”) according to the sixth embodiment.

The valve 600 includes a collection of body components 606, 608, 610 and 612. The valve 600 also includes a pump 620. The body components 606, 608, 610 and 612 are similar the body components of the first embodiment, and are arranged in a manner similar to that of the first embodiment. A processing screw 602 (hereafter called the “screw” 602) is located within a barrel 604 of a molding machine (not depicted). The body components 606, 608, 610 and 612 define an ingress 614, an egress 616, and a valve pathway 618 (hereafter called the “pathway” 618) that extends from the ingress 614 to the egress 616.

According to the sixth embodiment, the pump 620 is configured to extend into and cooperate with the pathway 618, to pump a molding material forwardly along the pathway 618, and to resist backflow of the molding material along the pathway 618. The pump 620 is configured as a turbine pump. The turbine pump includes a set of blades that are attached to the shaft 606 and extend radially from the shaft 606 to the sliding ring 612. The number of blades and the orientation of the blades can be varied in order to achieve a desired pumping performance and resistance to backflow of molding material, and the turbine pump depicted in FIG. 7 does not limit the scope of the present invention.

In a first variation of the sixth embodiment, the blades are attached to the sliding ring 612 and extend to the shaft 606.

In a second variation of the sixth embodiment, a second set of blades extends radially from the shaft 606 to the sliding ring 612. The second set of blades is offset rotationally with respect to the first set of blades (depicted in FIG. 7), and the second set of blades is axially offset from the first set of blades along the shaft 606.

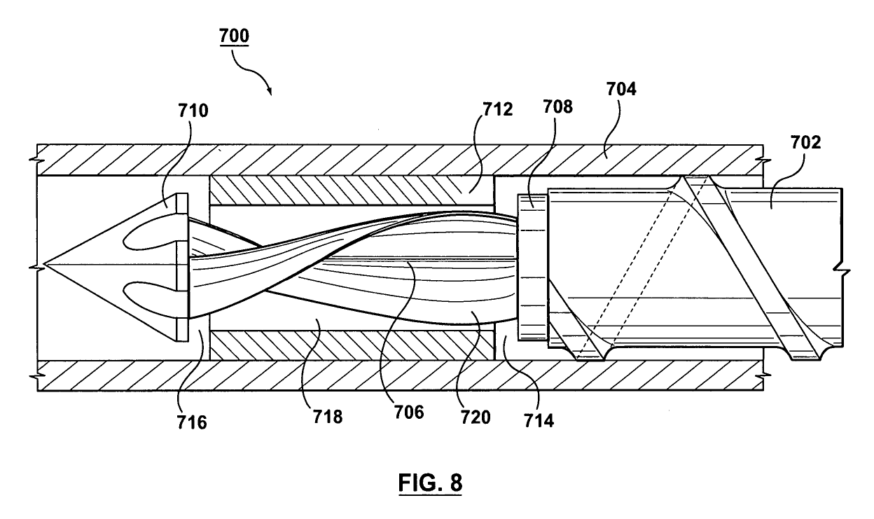

FIG. 8 is the longitudinal cross-sectional view of a valve 700 (herein called the “valve 700”) according to the seventh embodiment.

The valve 700 includes a collection of body components 706, 708, 710 and 712. The valve 700 also includes a pump 720. The body components 706, 708, 710 and 712 are similar the body components of the first embodiment, and are arranged in a manner similar to that of the first embodiment. A processing screw 702 (hereafter called the “screw 702”) is located within a barrel 704 of a molding machine (not depicted). The body components 706, 708, 710 and 712 define an ingress 714, an egress 716, and a valve pathway 718 (hereafter called the “pathway” 718) that extends from the ingress 714 to the egress 716.

According to the seventh embodiment, the pump 720 is configured to extend into and cooperate with the pathway 718, to pump a molding material forwardly along the pathway 718, and to resist backflow of the molding material along the pathway 718. The pump 720 is configured as a turbine pump. The pump 720 includes a pair of blades spanning a length of the shaft 706 and extending radially therefrom to the sliding ring 712. The pair of blades does not have to touch and/or attach to the retainers 708 and 710.

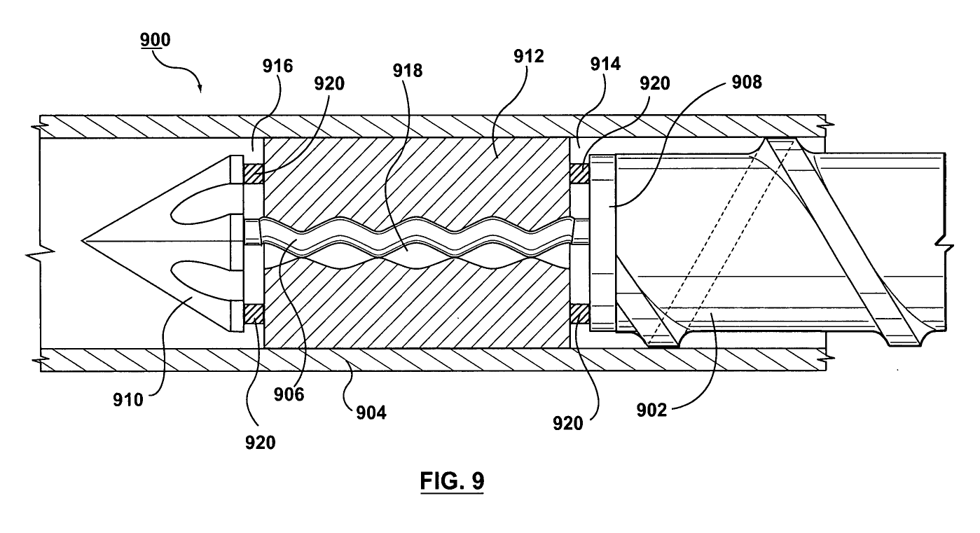

FIG. 9 is the cross-sectional view of a valve 900 (hereafter called the “valve 900”) according to the eighth embodiment.

The valve 900 includes a collection of body components 906, 908, 910 and 912. The valve 900 also includes a pump that is a progressing cavity pump. The pump is realized by a set of the body components that are shaped to cooperate as the pump. According to the eighth embodiment, the pump is the interactive shapes of the body components 906 and 912. The body components are as followings: a rearward retainer 908, a rotor 906, a stator 912 and a forward retainer 910. The rearward retainer 908 detachably attaches (by a thread engagement for instance) to a distal end of a processing screw 902 (hereafter called the “screw 902”) located within a barrel 904 of a molding machine (not depicted). Extending from the rearward retainer 908 is a helical rotor 906. A forward retainer 910 is attached to the distal end of the rotor 906. A stator 912 surrounds the rotor and frictionally engages the inner diameter of the barrel 904. The stator 912 has an inner surface with a double helical structure. The double helix has a depth larger than that of the rotor 906 and a pitch double that of the rotor 906. In this way, when the stator 912 and the rotor 906 are combined within the barrel 904, a valve pathway 918 is defined and consists of a series of cavities formed therebetween. The vale pathway 918 is hereafter called the “pathway” 918. The stator 912 further defines an ingress 914 and an egress 916 with the rearward retainer 908 and the forward retainer 910, respectively.

Although the geometry of its pumping elements may seem somewhat complex, the principle of progressing cavity pump operation is deceptively simple. The key components are the rotor and stator. The rotor is a single external helix with a round cross-section, precision machined from high-strength steel. The stator is a double internal helix precision machined from high-strength steel. Usually, the stator is made of tough, abrasion-resistant elastomer that is permanently bonded within an alloy steel tube (but the stator can be made of steel provided the tolerances are acceptable). As the rotor turns within the stator, cavities are formed which progress from the suction to the discharge end of the pump, conveying the pumped material. The continuous seal between the rotor and the stator helices keeps the fluid moving steadily at a fixed flow rate proportional to the pump's rotational speed.

Specifically, the progressing cavity pump is an example of a positive displacement pump. The progressing cavity pump has a helical rotor within a double helical stator. The stator and the rotor are tightly fit (or even compression fit) together such that a series of sealed cavities are produced between the stator and the rotor. The rotation of the rotor causes the sealed cavities to travel along from an inlet where fluid is input into the pump, to an outlet where fluid is urged out of the pump. Since a seal exists between the stator and rotor, no fluid is able to flow back through the pump.

The rotor 906 and the stator 912 tightly fit together. As the screw 902 rotates during recovery, the rotor 906 also rotates within the stator 912. Preferably, while the screw 102 rotates, the stator 912 is kept stationary by frictional engagement with the barrel 904. Rotational movement of the stator 912 is restricted or limited so the pump according to FIG. 9 works while allowing a limited translational movement of the stator 912 so the stator 912 can travel with the screw 902. The rotation of the screw 902 pushes material through the ingress 914 and into the pathway 918 defined by the series of cavities between the stator 912 and the rotor 906. The rotation of the rotor 906 continues to urge the material along the pathway and through the egress 916. Molding material continues to accumulate in front of the forward retainer 910 until the shot volume is reached.

Once the shot volume has been reached, the screw 902, and therefore the rotor 906, stops rotating. Since the stator 912 and the rotor 906 are in sealing contact with each other, backflow of material during the injection stroke is prevented from reaching the ingress 914.

In a first variation of the eighth embodiment, the pump 900 is a positive displacement pump. The positive displacement pump is one in which a definite volume of liquid is delivered for each cycle of pump operation. This volume is constant regardless of the resistance to flow offered by the system the pump is in, provided the capacity of a power unit driving the pump or pump component strength limits are not exceeded. The positive displacement pump delivers liquid in separate volumes with no delivery in between, although a pump having several chambers may have an overlapping delivery among individual chambers, which minimizes this effect.

In a variation, standoffs 920 are included. The standoffs 920 can extend from the stator 912 to the retainer 910 and the retainer 908. The purpose of the standoffs 920 is to limit the axial movement between the stator 912 and the rotor 906. It will be appreciated that the standoffs 920 can extend from the stator 912 to the retainers 910 and 908. The standoffs 920 do not block the flow of the molding material.

It will be appreciated that the valve of any of the embodiments of FIGS. 2 to 9 and 12 include a collection of body components. The collection of body components may be a single, unitary component or a plurality of body components.

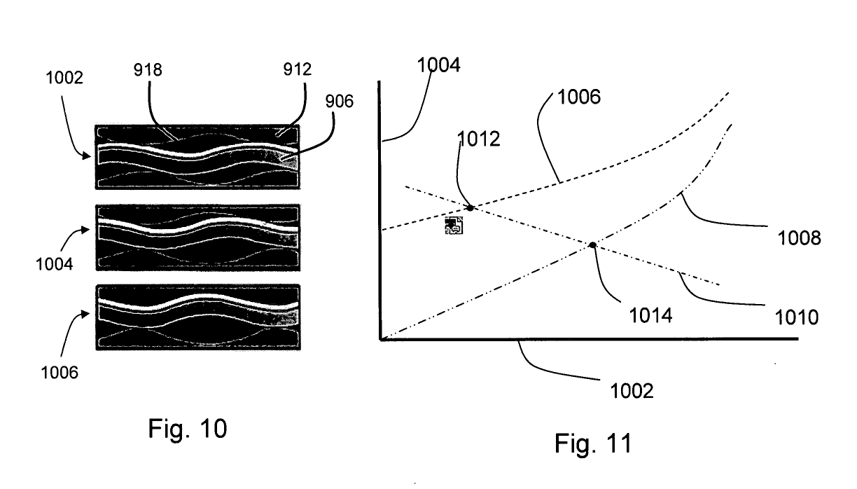

FIG. 10 represents the valve 900 of FIG. 9 at various rotational positions. Positions 1002, 1004 and 1006 represent exemplary rotational positions of the rotor 906 relative to the stator 912. As the rotor 906 is made to rotate relative to the stator 912, the rotor 906 moves molding material through the cavity 918.

FIG. 11 is a graph showing an operation curve of the valve 100 of FIG. 2. An x-axis 1002 represents pressure at a distal end of the screw 102 of FIG. 2 at a spot proximal to where the valve 100 is connected to the screw 102. A y-axis 1004 represents recovery rate (in cc per second) of a molding material accumulating in an accumulation zone that is located a downstream of the valve 100.

A curve 1006 represents a computed performance of the valve 100 (as a function of the pressure at the distal end of the screw 102) as the screw flight 120 rotates synchronously with the screw 100. A curve 1008 represents a measured performance of a known non-return valve (the known valve does not have a screw flight or other pump structure) that has a backflow restriction that is equivalent to that provided by the valve 100 (again, as a function of the pressure at the distal end of the screw 102). A curve 1010 represents an output of the screw 102, in which the screw 102 is rotated at a fixed rate (300 rpm), and the output is indicated in cc per second.

An intersection point 1012 represents an operating point of the valve 100 during a recovery cycle (that is, when the screw 102 is rotated to convey molding material forwardly). The intersection point 1012 is an operating point of the valve 100. An intersection point 1014 represents an operating point of the known valve during a recovery cycle (that is, when the screw 102 is rotated to convey molding material forwardly). The intersection point 1014 is an operating point of the known valve. The pressure of the intersection point 1012 is less than the pressure of the intersection point 1014. The recovery rate of the intersection point 1012 is greater than the recovery rate of the intersection point 1014. When the screw 102 is stopped from rotating, the valve 100 has a high resistance to backflow of molding material by introducing a high pressure drop that resists the backflow of molding material. It will be appreciated that FIG. 11 is applicable to the exemplary embodiments of the present invention.

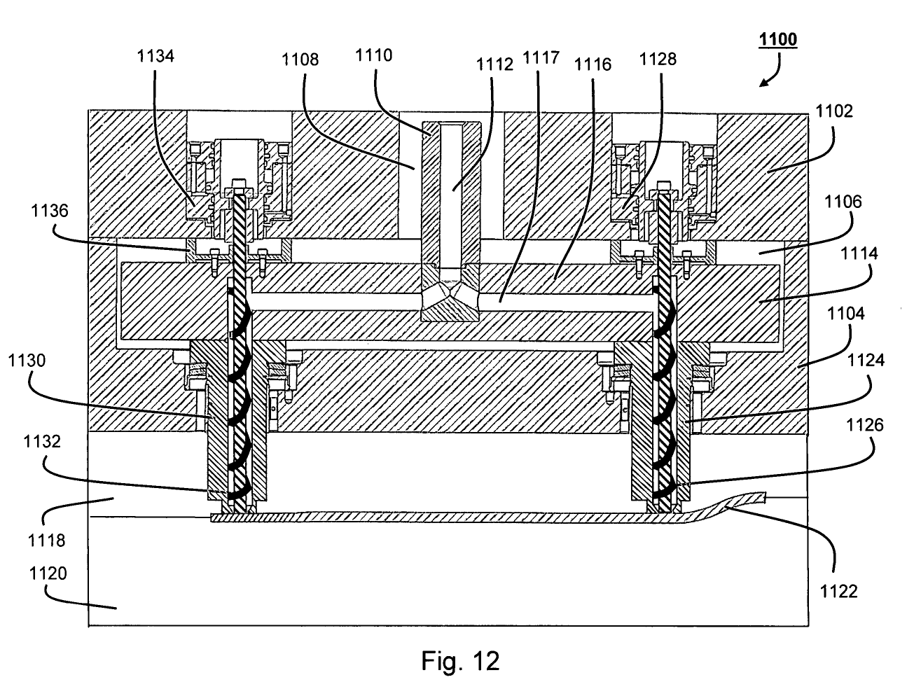

FIG. 12 is a cross-sectional view of a hot runner assembly 1100 according to a ninth embodiment of the present invention. The hot runner assembly 1100 is disposed between an injection unit (IU: not depicted) and complementary mold halves 1118 and 1120. The mold halves 1118 and 1120 cooperate to define a mold cavity 1122 therebetween. In operation, the hot runner assembly 1100 receives a molding material from the IU and then distributes and dispenses the molding material into the mold cavity 1122.

The hot runner assembly 1100 includes a valve 1124. The valve 1124 can also be called a nozzle. The valve 1124 includes a collection of body components that define a valve pathway or a valve passageway (or pathway). The collection of body components includes a unitary body component or includes distinct, detachable body components. The valve 1124 includes a pump 1126 configured to be placed in a valve pathway 1124 (or passageway) defined by the valve 1124, wherein the pump 1126 is configured to pump, responsive to actuation by a pump actuator 1128, a molding material through the valve pathway 1124 and towards a mold cavity 1122 defined by complementary mold halves 1118 and 1120. In an alternative, the valve 1124 and the pump actuator 1128 are sold together but in another alternative they are sold separately. In operation, the pump actuator 1128 is actuated to rotate the pump 1126 so that the pump 1126 pumps the molding material through the passageway of the valve 1124. In addition, the pump actuator 1128 also reciprocates the pump 1126 between a valve open position and a valve closed position. Preferably, the pump actuator 1128 is electromagnetically actuated responsive to receiving a control signal from a controller (not depicted). In the valve opened position, the molding material freely flows through the passageway of the valve 1124 and into the mold cavity 1122. The valve 1124 is depicted extending into the mold half 1118 but other variations contemplate the valve 1124 not extending into the mold half 1118.

Preferably, the hot runner assembly 1100 also includes an upper manifold 1102. The hot runner assembly 1100 also includes a lower manifold 1104 that mates with the upper manifold 1102. The upper manifold 1102 and the lower manifold 1104 cooperate to define a manifold cavity 1106 therebetween. The upper manifold 1102 also defines a manifold bore 1108 that extends from an outer surface of the upper manifold 1102 to the manifold cavity 1106.

Preferably, the hot runner assembly 1100 also includes a molding material conduit 1110 that is disposed within the manifold bore 1108. The molding material conduit 1110 defines a conduit passageway 1112 therein. A machine nozzle (not depicted) of the IU is operatively connectable to the molding material conduit 1110. The hot runner assembly 1100 also includes a manifold insert 1114 that is registered within the manifold cavity 1106 and between the upper manifold 1102 and the lower manifold 1104. The manifold insert defines a manifold insert passageway 1117 therein. The conduit passageway 1112 leads to and interfaces with the manifold insert passageway 1117. The manifold insert passageway 1117 leads to and interfaces with the passageway defined by the collection of body components of the valve 1124.

Preferably, the hot runner assembly 1100 includes one or more standoffs (such as, for example, a standoff 1136) used to locate and register the manifold insert relative to the upper manifold 1102 and/or the lower manifold 1104.

In an alternative, the hot runner assembly 1100 also includes a valve 1130. The valve 1130 includes a pump 1132 that cooperates with a passageway defined by the valve 1130. The manifold insert passageway 1117 leads to and interfaces with the passageway defined by the valve 1130. The valve 1130 also includes a pump actuator 1134 that is operatively connected to the pump 1132. The pump actuator 1134 operates in the same manner as the pump actuator 1128 associated with the valve 1124.

Depicted in FIG. 12, the pump 1126 and the pump 1132 include a screw flight. In an alternative, the pump 1126 and the pump 1132 to include any one of the pumps according to the embodiments depicted in FIGS. 2 to 9 inclusive in any combination and permutation thereof.

In an alternative, the valve 1124 and the valve 1130 are integrated into a selected component (or selected components) of the hot runner assembly 1100, such as the lower manifold 1104 for example. In this case, the lower manifold 1104 is a valve that houses the pump 1126 and the pump 1132. Generally, the valve 1124 and the valve 1130 are merely housing units that house their respective pumps.

In a first case, the pump 1126 is energized by the pump actuator 1128 to pump a molding material so as to assist or promote a flow of the molding material into the mold cavity 1122 (that is, the flow of the molding material is increased). In this case, the pressure drop across the pump 1126 is reduced, and as well, resistance to the flow of the molding material is also reduced. In an alternative of the first case, control of a pumping rate of the pump 1126 is performed responsive to an optimum mold cavity filling protocol, which is useful, for example, in large surface area molding applications. In another alternative of the first case, the pump 1126 reduces flow lines made in a molded article by control of a pumping rate of the pump 1126 responsive to a mold cavity filling protocol or requirement (such as, for example, a mold cavity filling profile and/or a mold cavity filling sequence. The first case permits, in some applications, optimization of molding material density in the mold cavity 1122. The first case also improves, in other applications, metering of the molding material and thereby realizing a potential reduction of molding material costs. Another advantage of the first case, in some applications, is reduced thermal gradient of the molding material disposed in the hot runner assembly 1100 (this arrangement improves the heat distributed in the molding material). Another advantage of the first case, in other applications, is improved mixing of the molding material so as to achieve improved uniform particle distribution within the molding material prior to injecting the molding material into the mold cavity 1122 (this arrangement improves product quality). Statements made above are equally applicable to the pump 1132.

In a second case, the pump 1126 is energized to pump molding material so as to resist or retard the flow of the molding material attempting to flow into the mold cavity 1122 (that is, the flow the molding material is reduced). In this case, the pressure drop across the pump 1126 is increased, and as well, resistance to the flow of the molding material is also increased. The second case is realized by reversing a pumping action of the pump 1126 in comparison to a pumping action of the pump 1126 associated with the first case. The second case permits, for this case, reduction of gate posting (also called gate vestige) by easing the flow of the molding material to the end of the cavity filling cycle. The second case also permits potential improvement of the aesthetic quality of a gate vestige that is left behind when the molded article is pulled away from the valve 1124. Statements made above are equally applicable to the pump 1132.

In an alternative, the hot runner assembly 1100 includes both the valve 1124 and the valve 1130 in which the pump 1126 of the valve 1124 pumps at a first pumping rate, and the pump 1132 of the valve 1130 pumps at a second pumping rate that is different from the first pumping rate. This arrangement permits balancing of the hot runner assembly 1100 according to a desired balancing schema.

In an alternative, the hot runner assembly 1100 includes both the valve 1124 and the valve 1130 in which the valves 1124, 1130 sequentially fill the mold cavity 1122, and pumping rates of each pump 1126, 1132 of each respective valve 1124, 1130 is different from each another. This arrangement leads to a reduction of clamping pressure applied to the mold halves 1118 and 1120.

In an alternative, the pump 1126 is used in a thixo-molding system (not depicted) for processing a thixotropic material (such as, a metallic alloy of magnesium, etc). The thixo-molding system includes a thixo injection unit and/or a thixo hot runner assembly and any combination and permutation thereof. The thixotropic material is solidified to form a thixo plug, and the thixo plug is re-melted to be flowable when sheered by a pump action of the pump 1126. The prior art related to thixo-molding requires blowing out of the thixo plug at a high blow out pressure. The technical advantage of using the pump 1126 in the thixo-molding system is that the high thixo plug blow out pressure is avoided (thus reducing the possibility of inadvertent operator injury). Statements made above are equally applicable to the pump 1132.

In an alternative, the pump 1126 includes axially-staged mechanisms, wherein each of the axially-staged mechanisms is configured to perform a dedicated molding material processing function in addition to a pumping function of the pump 1126. The dedicated molding material processing function includes, for example, any one of the following: mixing, sheering, and any combination and permutation thereof. Statements made above are equally applicable to the pump 1132.

In an alternative, the pump 1126 is used for pumping fiber-laden molding material. The fiber used in the fiber-laden molding material includes, for example, glass fibers. The glass fibers tend to coalesce or collect into fiber bundles while they are distributed within the hot runner assembly 1100. Advantageously, for this alternative, the pump 1126 acts to de-bundle and to disperse the glass fibers prior to injecting the molding material into the mold cavity 1122. Statements made above are equally applicable to the pump 1132.

In an alternative, an additive is conveyed to the pump 1126 via another conduit (not depicted), and the conduit is defined in the hot runner assembly 1100. The pump mixes the additive (such as, a colored pigment for example) to the molding material prior to the molding material being made to enter the mold cavity 1122. The mixing of the additive is performed by the pump 1126 as close as possible to the mold cavity 1122. When a color change is required, advantageously, for this alternative, this arrangement avoids having to purge colored molding material from the entire hot runner assembly 1100 and/or an injection unit (not depicted), and as a result a small amount of molding material is wasted by avoidance of flushing out and wasting molding material from more than the local material disposed near the pump 1126. Statements made above are equally applicable to the pump 1132.

It will be appreciated that the embodiments described above are applicable to molding materials such as plastic resin, metal (such as alloys of magnesium), and/or metals in a thixotropic state, etc.

In an embodiment, a kit of a molding system is provided. The kit includes a pump configured to cooperate with a valve pathway defined by a molding system valve. The pump is, for example, any of the pumps depicted above. The molding system valve is configured to cooperate with the molding system. The molding system includes, for example, any one of an injection unit of a molding machine, a hot runner assembly and any combination and permutation thereof.

Generally, another aspect of the present invention provides a molding system, including a pump configured to cooperate with a valve pathway defined by a molding system valve, the molding system valve configured to cooperate with the molding system. The molding system includes any one of an injection unit of a molding machine, a hot runner assembly and any combination and permutation thereof.

It will be appreciated that some elements may be adapted for specific conditions or functions. The concepts described above may be further extended to a variety of other applications that are clearly within the scope of the present invention. Having thus described the embodiments, it will be apparent to those skilled in the art that modifications and enhancements are possible without departing from the concepts as described. Therefore, what is intended to be protected by way of letters patent should be limited only by the scope of the following claims:

1. A kit of a molding system, comprising:
a pump configured to be placed in a valve pathway defined by a valve, wherein the pump is configured to pump, responsive to actuation by a pump actuator, a molding material through the valve pathway and towards a mold cavity defined by complementary mold halves.

2. The kit of claim 1, wherein:
the pump actuator is configured to include a processing screw of an injection unit, the processing screw configured to connect with a processing screw actuation assembly;
the pump is configured to pump a molding material forwardly along the valve pathway as the processing screw is actuated to rotate during a recovery cycle; and
the pump is configured to resist backflow of a molding material along the valve pathway as the processing screw is actuated to translate during an injection cycle.

3. The kit of claim 1, wherein:
the pump is configured to include a screw pump.

4. The kit of claim 1, wherein:
the pump is configured to include a screw pump; and
the screw pump is configured to include any one of a uniform bolt thread, a screw flight and any combination and permutation thereof, wherein:
the uniform bolt thread is configured to form any one of a square shaped profile, a v-shaped profile and any combination and permutation thereof; and
the screw flight is configured to form any one of a square shaped profile, a v-shaped profile and any combination and permutation thereof.

5. The kit of claim 1, wherein:
the pump is configured to include:
a screw flight; and
another screw flight configured to be aligned out of phase relative to the screw flight.

6. The kit of claim 1, wherein:
the pump is configured to include:
a screw flight configured to include discontinuous portions; and
another screw flight configured to include continuous portions aligned with the discontinuous portions, the continuous portions configured to redirect a backflow of the molding material passing through the discontinuous portions.

7. The kit of claim 1, wherein:
the pump is configured to include a screw flight; and
the valve is configured to include a collection of body components, the collection of body components configured to define the valve pathway, the collection of body components is configured to include:
(i) a rearward retainer configured to attach to a processing screw of an injection unit;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

8. The kit of claim 7, wherein:
the screw flight is configured to attach to any one of:
(i) the central portion, and the screw flight extends from the central portion to the slidable ring;
(ii) the slidable ring, and the screw flight extends from the slidable ring to the central portion;
(iii) the rearward retainer, and the screw flight spans a length of the central portion, and the screw flight extends between the slidable ring and the central portion; and
(iv) the forward retainer, the screw flight spans a length of the central portion, and the screw flight extends between the slidable ring and the central portion.

9. The kit of claim 1, wherein:
the pump is configured to include a positive displacement pump.

10. The kit of claim 1, wherein:
the pump is configured to include a positive displacement pump; and
the valve is configured to include a collection of body components, the collection of body components configured to define the valve pathway, the collection of body components configured to include interactive shapes, the interactive shapes configured to implement the positive displacement pump.

11. The kit of claim 1, wherein:
the pump is configured to include a positive displacement pump; and
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

12. The kit of claim 1, wherein:
the pump is configured to include a progressing cavity pump.

13. The kit of claim 1, wherein:
the valve is configured to include a collection of body components, the body components configured to define the valve pathway; and
the pump is configured to include a progressing cavity pump, the progressing cavity pump is configured to include:
a stator; and
a rotor configured to cooperate with the stator.

14. The kit of claim 13, wherein:
the collection of body components is configured to include a rearward retainer, the rearward retainer configured to attach to a processing screw;
the rotor is configured to include a central portion, the central portion configured to extend from the rearward retainer;
the stator is configured to include a slidable ring, the slidable ring configured to slide coaxially relative to the central portion, the rearward retainer is configured to define a rearward extent of movement of the slidable ring; and
the collection of body components is configured to include:
a forward retainer configured to:
engage with a distal end of the central portion, and
define a forward extent of movement of the slidable ring.

15. The kit of claim 1, wherein:
the pump is configured to include a turbine pump, the turbine pump is configured to include a set of blades.

16. The kit of claim 1, wherein:
the pump is configured to include a turbine pump, the turbine pump is configured to include a set of blades, and
the valve is configured to include a collection of body components, the collection of body components configured to define the valve pathway, the collection of body is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

17. The kit of claim 16, wherein:
the set of blades is configured to extend from any one of the following:
(i) the central portion;
(ii) the slidable ring;
(iii) the rearward retainer, and
(iv) the forward retainer.

18. The kit of claim 1, wherein:
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

19. The kit of claim 1, wherein:
the pump is configured to add a head pressure to the molding material being pumped by the pump.

20. The kit of claim 1, wherein:
the molding system is configured to include any one of an injection unit of a molding machine, a hot runner assembly and any combination and permutation thereof.

21. The kit of claim 1, wherein:
the pump is configured to cooperate with any one of a hot runner assembly, an injection unit and any combination and permutation thereof.

22. The kit of claim 1, wherein:
the pump is configured to include axially-staged mechanisms, each of the axially-staged mechanisms is configured to perform a dedicated molding material processing function.

23. The kit of claim 1, wherein:
the pump is configured to be a member of a plurality of pumps, the plurality of pumps configured to balance a hot runner assembly according to a predetermined balancing schema.

24. The kit of claim 1, wherein:
the pump is configured to be a member of a plurality of pumps, the plurality of pumps configured to sequentially pump the molding material into a mold cavity defined by complementary mold halves.

25. The kit of claim 1, wherein:
the molding material is configured to include thixotropic material; and
the pump is configured to pump the thixotropic material.

26. The kit of claim 1, wherein:
the molding material is configured to include a fiber-laden molding material; and
the pump is configured to:
pump the fiber-laden molding material; and
de-bundle the glass fibers of the fiber-laden molding material.

27. The kit of claim 1, wherein:
the pump is configured to pump an additive into the molding material.

28. A molding system, comprising:
a valve body; and
a pump configured to be placed in a valve pathway defined by the valve body, wherein the pump is configured to pump, responsive to actuation by a pump actuator, a molding material through the valve pathway and towards a mold cavity defined by complementary mold halves.

29. The molding system of claim 28, wherein:
the pump actuator is configured to include a processing screw of an injection unit, the processing screw configured to connect with a processing screw actuation assembly;
the pump is configured to pump a molding material forwardly along the valve pathway as the processing screw is actuated to rotate during a recovery cycle; and
the pump is configured to resist backflow of a molding material along the valve pathway as the processing screw is actuated to translate during an injection cycle.

30. The molding system of claim 28, wherein:
the pump is configured to include a screw pump.

31. The molding system of claim 28, wherein:
the pump is configured to include a screw pump; and
the screw pump is configured to include any one of a uniform bolt thread, a screw flight and any combination and permutation thereof, wherein:
the uniform bolt thread is configured to form any one of a square shaped profile, a v-shaped profile and any combination and permutation thereof; and
the screw flight is configured to form any one of a square shaped profile, a v-shaped profile and any combination and permutation thereof.

32. The molding system of claim 28, wherein:
the pump is configured to include:
a screw flight; and
another screw flight configured to be aligned out of phase relative to the screw flight.

33. The molding system of claim 28, wherein:
the pump is configured to include:
a screw flight configured to include discontinuous portions; and
another screw flight configured to include continuous portions aligned with the discontinuous portions, the continuous portions configured to redirect a backflow of the molding material passing through the discontinuous portions.

34. The molding system of claim 28, wherein:
the pump is configured to include a screw flight; and
the valve is configured to include a collection of body components, the collection of body components configured to define the valve pathway, the collection of body components is configured to include:
(i) a rearward retainer configured to attach to a processing screw of an injection unit;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

35. The molding system of claim 7, wherein:
the screw flight is configured to attach to any one of:
(i) the central portion, and the screw flight extends from the central portion to the slidable ring;
(ii) the slidable ring, and the screw flight extends from the slidable ring to the central portion;
(iii) the rearward retainer, and the screw flight spans a length of the central portion, and the screw flight extends between the slidable ring and the central portion; and
(iv) the forward retainer, the screw flight spans a length of the central portion, and the screw flight extends between the slidable ring and the central portion.

36. The molding system of claim 28, wherein:
the pump is configured to include a positive displacement pump.

37. The molding system of claim 28, wherein:
the pump is configured to include a positive displacement pump; and
the valve is configured to include a collection of body components, the collection of body components configured to define the valve pathway, the collection of body components configured to include interactive shapes, the interactive shapes configured to implement the positive displacement pump.

38. The molding system of claim 28, wherein:
the pump is configured to include a positive displacement pump; and
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

39. The molding system of claim 28, wherein:
the pump is configured to include a progressing cavity pump.

40. The molding system of claim 28, wherein:
the valve is configured to include a collection of body components, the body components configured to define the valve pathway; and
the pump is configured to include a progressing cavity pump, the progressing cavity pump is configured to include:
a stator; and
a rotor configured to cooperate with the stator.

41. The molding system of claim 40, wherein:
the collection of body components is configured to include a rearward retainer, the rearward retainer configured to attach to a processing screw;
the rotor is configured to include a central portion, the central portion configured to extend from the rearward retainer;
the stator is configured to include a slidable ring, the slidable ring configured to slide coaxially relative to the central portion, the rearward retainer is configured to define a rearward extent of movement of the slidable ring; and
the collection of body components is configured to include:
a forward retainer configured to:
engage with a distal end of the central portion, and
define a forward extent of movement of the slidable ring.

42. The molding system of claim 28, wherein:
the pump is configured to include a turbine pump, the turbine pump is configured to include a set of blades.

43. The molding system of claim 28, wherein:
the pump is configured to include a turbine pump, the turbine pump is configured to include a set of blades, and
the valve is configured to include a collection of body components, the collection of body components configured to define the valve pathway, the collection of body is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

44. The molding system of claim 43, wherein:
the set of blades is configured to extend from any one of the following:
(i) the central portion;
(ii) the slidable ring;
(iii) the rearward retainer, and (iv) the forward retainer.

45. The molding system of claim 28, wherein:
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

46. The molding system of claim 28, wherein:
the pump is configured to add a head pressure to the molding material being pumped by the pump.

47. The molding system of claim 28, wherein:
the pump is configured to cooperate with any one of a hot runner assembly, an injection unit and any combination and permutation thereof.

48. The molding system of claim 28, wherein:
the pump is configured to include axially-staged mechanisms, each of the axially-staged mechanisms is configured to perform a dedicated molding material processing function.

49. The molding system of claim 28, wherein:
the pump is configured to be a member of a plurality of pumps, the plurality of pumps configured to balance a hot runner assembly according to a predetermined balancing schema.

50. The molding system of claim 28, wherein:
the pump is configured to be a member of a plurality of pumps, the plurality of pumps configured to sequentially pump the molding material into a mold cavity defined by complementary mold halves.

51. The molding system of claim 28, wherein:
the molding material is configured to include thixotropic material; and
the pump is configured to pump the thixotropic material.

52. The molding system of claim 28, wherein:
the molding material is configured to include a fiber-laden molding material; and
the pump is configured to:
pump the fiber-laden molding material; and
de-bundle the glass fibers of the fiber-laden molding material.

53. The molding system of claim 28, wherein:
the pump is configured to pump an additive into the molding material.

54. A valve of a molding system, comprising:
a pump configured to be placed in a valve pathway defined by a valve, wherein the pump is configured to pump, responsive to actuation by a pump actuator, a molding material through the valve pathway and towards a mold cavity defined by complementary mold halves.

55. The valve of claim 54, wherein:
the pump actuator is configured to include a processing screw of an injection unit, the processing screw configured to connect with a processing screw actuation assembly;
the pump is configured to pump a molding material forwardly along the valve pathway as the processing screw is actuated to rotate during a recovery cycle; and
the pump is configured to resist backflow of a molding material along the valve pathway as the processing screw is actuated to translate during an injection cycle.

56. The valve of claim 54, wherein:
the pump is configured to include a screw pump.

57. The valve of claim 54, wherein:
the pump is configured to include a screw pump; and
the screw pump is configured to include any one of a uniform bolt thread, a screw flight and any combination and permutation thereof, wherein:
the uniform bolt thread is configured to form any one of a square shaped profile, a v-shaped profile and any combination and permutation thereof; and
the screw flight is configured to form any one of a square shaped profile, a v-shaped profile and any combination and permutation thereof.

58. The valve of claim 54, wherein:
the pump is configured to include:
a screw flight; and
another screw flight configured to be aligned out of phase relative to the screw flight.

59. The valve of claim 54, wherein:
the pump is configured to include:
a screw flight configured to include discontinuous portions; and
another screw flight configured to include continuous portions aligned with the discontinuous portions, the continuous portions configured to redirect a backflow of the molding material passing through the discontinuous portions.

60. The valve of claim 54, wherein:
the pump is configured to include a screw flight; and
the valve is configured to include a collection of body components, the collection of body components configured to define the valve pathway, the collection of body components is configured to include:
(i) a rearward retainer configured to attach to a processing screw of an injection unit;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

61. The valve of claim 60, wherein:
the screw flight is configured to attach to any one of:
(i) the central portion, and the screw flight extends from the central portion to the slidable ring;
(ii) the slidable ring, and the screw flight extends from the slidable ring to the central portion;
(iii) the rearward retainer, and the screw flight spans a length of the central portion, and the screw flight extends between the slidable ring and the central portion; and
(iv) the forward retainer, the screw flight spans a length of the central portion, and the screw flight extends between the slidable ring and the central portion.

62. The valve of claim 54, wherein:
the pump is configured to include a positive displacement pump.

63. The valve of claim 54, wherein:
the pump is configured to include a positive displacement pump; and
the valve is configured to include a collection of body components, the collection of body components configured to define the valve pathway, the collection of body components configured to include interactive shapes, the interactive shapes configured to implement the positive displacement pump.

64. The valve of claim 54, wherein:
the pump is configured to include a positive displacement pump; and
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

65. The valve of claim 54, wherein:
the pump is configured to include a progressing cavity pump.

66. The valve of claim 54, wherein:
the valve is configured to include a collection of body components, the body components configured to define the valve pathway; and
the pump is configured to include a progressing cavity pump, the progressing cavity pump is configured to include:
a stator; and
a rotor configured to cooperate with the stator.

67. The valve of claim 66, wherein:
the collection of body components is configured to include a rearward retainer, the rearward retainer configured to attach to a processing screw;
the rotor is configured to include a central portion, the central portion configured to extend from the rearward retainer;
the stator is configured to include a slidable ring, the slidable ring configured to slide coaxially relative to the central portion, the rearward retainer is configured to define a rearward extent of movement of the slidable ring; and
the collection of body components is configured to include:
a forward retainer configured to:
engage with a distal end of the central portion, and
define a forward extent of movement of the slidable ring.

68. The valve of claim 54, wherein:
the pump is configured to include a turbine pump, the turbine pump is configured to include a set of blades.

69. The valve of claim 54, wherein:
the pump is configured to include a turbine pump, the turbine pump is configured to include a set of blades, and
the valve is configured to include a collection of body components, the collection of body components configured to define the valve pathway, the collection of body is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

70. The valve of claim 69, wherein:
the set of blades is configured to extend from any one of the following:
(i) the central portion;
(ii) the slidable ring;
(iii) the rearward retainer, and
(iv) the forward retainer.

71. The valve of claim 54, wherein:
the valve is configured to include a collection of body components, the collection of body components configured to define the valve pathway, the collection of body components is configured to include:
(i) a rearward retainer configured to attach to a processing screw;
(ii) a central portion configured to extend from the rearward retainer;
(iii) a slidable ring configured to slide coaxially relative to the central portion, the rearward retainer defines a rearward extent of movement of the slidable ring; and
(iv) a forward retainer configured to:
engage with a distal end of the central portion, and
define a forward extent of movement of the slidable ring.

72. The valve of claim 54, wherein:
the pump is configured to add a head pressure to the molding material being pumped by the pump.

73. The valve of claim 54, wherein:
the molding system is configured to include any one of an injection unit of a molding machine, a hot runner assembly and any combination and permutation thereof.

74. The valve of claim 54, wherein:
the pump is configured to cooperate with any one of a hot runner assembly, an injection unit and any combination and permutation thereof.

75. The valve of claim 54, wherein:
the pump is configured to include axially-staged mechanisms, each of the axially-staged mechanisms is configured to perform a dedicated molding material processing function.

76. The valve of claim 54, wherein:
the pump is configured to be a member of a plurality of pumps, the plurality of pumps configured to balance a hot runner assembly according to a predetermined balancing schema.

77. The valve of claim 54, wherein:
the pump is configured to be a member of a plurality of pumps, the plurality of pumps configured to sequentially pump the molding material into a mold cavity defined by complementary mold halves.

78. The valve of claim 54, wherein:
the molding material is configured to include thixotropic material; and
the pump is configured to pump the thixotropic material.

79. The valve of claim 54, wherein:
the molding material is configured to include a fiber-laden molding material; and
the pump is configured to:
pump the fiber-laden molding material; and
de-bundle the glass fibers of the fiber-laden molding material.

80. The valve of claim 54, wherein:
the pump is configured to pump an additive into the molding material.
